(19) United States
(12) Patent Application Publication
(10) Pub. No.: US 2025/0392181 A1
(43) Pub. Date: Dec. 25, 2025

(54) WIRING ELEMENT, STATOR, ROTOR, METHOD FOR PRODUCING A STATOR, METHOD FOR PRODUCING A ROTOR, AND KIT OF PARTS

(71) Applicant: Schaeffler Technologies AG & Co. KG, Herzogenaurach (DE)

(72) Inventors: Florian Sell-Le Blanc, Karlsruhe (DE); Jochen Klee, Duren (DE); Hans Romeis, Scheinfeld (DE); Michael Preininger, Nurnberg (DE); Oliver Steffen, Herzogenaurach (DE); Nico Langberg, Neustrelitz (DE)

(73) Assignee: Schaeffler Technologies AG & Co. KG, Herzogenaurach (DE)

(21) Appl. No.: 18/881,333

(22) PCT Filed: Jul. 5, 2023
(86) PCT No.: PCT/DE2023/100507

§ 371 Date: Jan. 6, 2025

(30) Foreign Application Priority Data
Jul. 6, 2022 (DE) 10 2022 116 826.3

(51) Int. Cl. H02K 3/34; H02K 15/104

(52) U.S. Cl. CPC H02K 3/34; H02K 15/104

(57) ABSTRACT

The disclosure relates to a wiring element, in particular for electrically contacting two mutually spaced contact elements, comprising a first wire end and a second wire end. The wiring element has an insulation between the first wire end and the second wire end, wherein the insulation is made of a flat insulation element that at least partly surrounds the wiring element and has a first edge extending in the longitudinal extension of the wiring element and a second edge extending in the longitudinal extension of the wiring element. The first edge is fixed relative to the second edge of the flat insulation element by means of a bonded connection and/or a form-fitting connection such that the wiring element is surrounded by the flat insulation element in a tubular manner.

### CROSS-REFERENCE TO RELATED APPLICATIONS

This application is the U.S. National Phase of PCT Appln. No. PCT/DE2023/100507, filed Jul. 5, 2023, which claims the benefit of German Patent Appln. No. 102022116826.3, filed Jul. 6, 2022, the entire disclosures of which are incorporated by reference herein.

### TECHNICAL FIELD

The present disclosure relates to a wiring element, in particular for electrically contacting two mutually spaced contact elements disclosure.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to.

A detailed description of an electric drive can be found in an article in the German automotive magazine ATZ, volume 63, 05/20 6, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor that is arranged to be concentric and coaxial with a bevel gear differential, wherein a shiftable 2-speed planetary gear set is arranged in the power train between the electric motor and the bevel gear differential and is also positioned to be coaxial with the electric motor or the bevel gear differential or spur gear differential. The drive unit is very compact and allows for a good compromise between gradability, acceleration and energy consumption due to the shiftable 2-speed planetary gear set. Such drive units are also referred to as e-axles.

In addition to purely electrically operated drivetrains, hybrid drivetrains are also known. Such drivetrains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, drive can also be provided by the internal combustion engine and the electric motor at the same time in certain operating situations.

In addition to their use in electromobility, electric machines are also used, for example, as electric motors for automation or as industrial motors. Especially with industrial engines, there is a large variety of types with different quantities and requirements. One approach to mastering this diversity is to use common geometries, e.g., laminations, in order to then differentiate the product into types with their properties by connecting the individual coils.

For the development of electrical machines, in particular electrical machines for the above-mentioned hybrid or fully electric motor vehicles or also for wheel hub drives, fundamentally different winding technologies for a stator of an electrical machine are known.

For electrical insulation in multi-phase windings, both the dielectric strength of the individual coils of a phase and the dielectric strength of the connecting wires between the coils within a phase and between the phases, e.g., when implementing a star/delta configuration, must be ensured. The electrical insulation of the winding heads is typically carried out using so-called phase separators, wherein these are designed as flat insulation materials in a defined 2D or 2.5D cut (embossing/curvature). When wiring the windings or the winding ends on one of the winding heads, so-called surrounding insulation elements are used, which are intended to prevent electrical contact between wiring elements on or in the winding head of other coils of the same or other phases.

However, it is usually not possible, or only possible with great effort, to automate the process of wiring or insulating the electrical conductors intended for wiring. One example is the comparatively complex automation in the axial joining of tube systems onto flexible connecting wires. Even alternative insulating bandages can only be automated to a limited extent due to the accessibility of the joining/insulation point.

### SUMMARY

It is therefore the object of the present disclosure to provide a wiring element, in particular for electrically contacting two mutually spaced contact elements, which can be provided with insulation in a simple, automated manner. It is a further object of the disclosure to realize a stator with an improved wiring element and a rotor with an improved wiring element. It is also the object of the disclosure to provide an optimized process for producing a stator and for producing a rotor. Finally, it is also an object of the disclosure to realize a kit of parts for producing an insulation of a wiring element for electrically contacting two mutually spaced contact elements.

This object is achieved by a wiring element, in particular for electrically contacting two mutually spaced contact elements,
comprising a first wire end and a second wire end, wherein the wiring element has an insulation between its first wire end and its second wire end, wherein the insulation is made of a flat insulation element that at least partly surrounds the wiring element, which flat insulation element has a first edge extending in the longitudinal extension of the wiring element and a second edge extending in the longitudinal extension of the wiring element,
wherein the first edge is fixed relative to the second edge of the flat insulation element by means of a bonded connection and/or a form-fitting connection such that the wiring element is surrounded by the flat insulation element in a tubular manner.

This has the advantage that the wiring element can be produced in a highly automated manner. Preferably, a similar or even the same material is used for the flat insulation element as is provided for the phase separators of the coils in the winding head. This means that one material can be used throughout for the insulation of the winding, which saves costs in material provision and logistics as well as in product development and material qualification. Typically, the material thickness is thinner compared to the previously used tubes, which is why a more compact winding head can be created due to easier routing of the jumper wires and the associated smaller space requirement.

The layer thicknesses of the flat insulation material can also be flexibly adjusted based on the selected degree of overlap in the outer area. By using a flat insulation material, it is also possible to further improve the insulating properties of the material by subsequently applying secondary insulation, for example by drip or dip impregnation. This is typically not possible when using tubes.

The wiring element may be formed by one wiring wire or a plurality of wiring wires. It is also conceivable that the wiring element consists of a wire bundle in which individual wiring wires are arranged, for example, twisted. In particular, the wiring element is designed to be flexible. To fix the wires before the actual electrical contact, it can be advantageous to fix them with the help of a cable lug. This is typically combined with the cost-effective welding process of thermo-compression or resistance welding. Especially for a larger number of parallel conductors of a wiring wire, the use of contact elements such as cable lugs, welding sleeves or similar elements is preferred.

The flat insulation element preferably has a foil-like shape. For example, a flat insulation element can be designed as an insulation paper or an insulation fabric. In principle, it is of course also possible to form the flat insulation element from an electrically insulating plastic film. A flat insulation element can be provided as a flat and/or level blank. Preferably, the flat insulation element has a rectangular shape. In principle, of course, any other flat shapes are also conceivable.

According to the disclosure, the first edge is fixed relative to the second edge of the flat insulation element by means of a bonded connection and/or a form-fitting connection. The form-fitting connection can be achieved, for example, by folding the edges. The use of an adhesive is particularly advantageous for a bonded connection. It is particularly advantageous that at least one of the edges is already provided with an adhesive strip, so that application of an adhesive when producing the insulation of the wiring element can be avoided. A combination of the processes in a sequence can also bring advantages from a process point of view, e.g., through a temporary fixation by means of form-fitting connection, which is subsequently additionally fixed in the process chain by secondary insulation by means of a bonded connection.

For fixation by means of form-fitting connection, it may be useful to adapt the geometries of the edges to each other so that dismantling of the edges of the flat insulation element in the form of self-hammering is avoided. This principle is based on a receiving contour and a penetrating contour on the opposite side, similar to the key-lock principle. The receiving contour can be designed in different ways, for example through undercuts in the flank contour, as well as perforations or pockets.

According to an advantageous embodiment of the disclosure, it can be provided that the bonded connection is produced by means of an adhesive, which is formed as a strip on the first edge which extends at least partly in the longitudinal extension of the wiring element and/or
the bonded connection is produced by means of an adhesive, which is formed as a strip on the second edge which extends at least partly in the longitudinal extension of the wiring element. The advantage of this embodiment is that a particularly safe and simple materially bonded connection can be realized.

The adhesive can be applied in strip form. This can be done, for example, by a plurality of adhesive dots arranged in strips, a continuous or interrupted adhesive line. The stripe can be straight, zig-zag or wavy.

The object of the disclosure is further achieved by a stator of an electric machine having a stator winding, wherein at least one wiring element according to one of claims 1-2 is used for the electrical wiring of the stator winding. The design of the stator with the wiring element enables a more compact winding head on the product side with reduced material and logistics costs. On the process side, automation of the wiring and insulation processes is possible, which saves costs in series production. This means that the customer's product flexibility is maintained and cost potentials can be implemented in both product design and production.

Furthermore, the object of the disclosure can also be achieved by a rotor of an electric machine having a rotor winding, wherein at least one wiring element according to one of claims 1-2 is used for the electrical wiring of the rotor winding. The advantageous effect of this embodiment is based on the fact that, even for wound rotors, for example of DC machines, the wiring must be carried out in a small installation space. The demonstrated solution is particularly suitable for this purpose due to its good installation properties.

In addition, the object of the disclosure is also achieved by a method for producing a stator of an electric machine, comprising the following steps:
provision of a stator;
provision of a stator winding,
provision of a wiring element for electrically contacting two mutually spaced contact elements of the stator winding,
provision of a flat insulation element, which has a first edge extending in the longitudinal extension of the wiring element and a second edge extending in the longitudinal extension of the wiring element,
a) establishing an electrical contact between the two mutually spaced contact elements of the stator winding by means of the wiring element,
b) insertion of the wiring element into the flat insulation element,
c) folding over the flat insulation element so that the wiring element is surrounded in a tubular manner by the flat insulation element,
d) fixing the first edge relative to the second edge of the flat insulation element by means of a bonded connection and/or a form-fitting connection.

This has the particular effect of producing a structurally compact but flexible insulation of the wiring wires in terms of the product properties, which is particularly suitable for automation due to the defined process sequence.

Furthermore, the object of the disclosure can also be achieved by a method for producing a rotor of an electrical machine, comprising the following steps:
provision of a rotor,
provision of a rotor winding,
provision of a wiring element for electrically contacting two mutually spaced contact elements of the rotor winding,
provision of a flat insulation element, which has a first edge extending in the longitudinal extension of the wiring element and a second edge extending in the longitudinal extension of the wiring element,
a) establishing an electrical contact between the two mutually spaced contact elements of the rotor winding by means of the wiring element,
b) insertion of the wiring element into the flat insulation element,
c) folding over the flat insulation element so that the wiring element is surrounded in a tubular manner by the flat insulation element,
d) fixing the first edge relative to the second edge of the flat insulation element by means of a bonded connection and/or a form-fitting connection.

In a likewise preferred embodiment variant of the disclosure, it can also be provided that before inserting the wiring element into the flat insulation element, the flat insulation element is preformed into a contour with a V-shaped or U-shaped cross-section. This can help to ensure that the conductors are centered around the center position of the flat insulation element, especially in the case of large conductor cross-sections or a high number of parallel sub-conductors. This simplifies the wrapping step and ensures improved positional accuracy of the contact elements and improved process capability of the assembly.

It may also be advantageous to further develop the disclosure in such a way that the preforming of the flat insulation element is carried out by means of a mold which has a channel which is open on one side in the cross-section, in particular a V-shaped or U-shaped channel, into which the flat insulation element is inserted. The advantage of this is that, depending on the specific contour of the wiring elements, individual guiding properties of the flat insulation element can be developed to enable optimal centering for the given product contour.

According to a further preferred embodiment of the subject matter of the disclosure, it can be provided that the flat insulation element is drawn into and/or held in the channel by means of a negative pressure. This can be used to prevent relative movement in the plane of the flat insulation element when the contact element and flat insulation element are combined.

Finally, the disclosure can also be advantageously designed such that the channel has two channel wings that are movable relative to one another.

Finally, the object of the disclosure is also achieved by a kit of parts for producing an insulation of a wiring element for electrically contacting two mutually spaced contact elements, comprising:
A plurality of wiring elements each for electrically contacting two mutually spaced contact elements, each having a first wire end and a second wire end,
A plurality of flat insulation elements, which have a first edge extending in the longitudinal extension of the wiring element having a first adhesive strip and a second edge extending in the longitudinal extension of the wiring element,
a mold, which has a channel which is open on one side in the cross-section, in particular a V-shaped or U-shaped channel, into which the flat insulation element can be inserted.

The advantage that this offers is that all elements required for assembly, wiring and insulation can be made available in a particularly assembly-friendly and convenient manner.

The kit of parts can, for example, be a packaging unit. Furthermore, it is possible to design the kit of parts as a compilation of separate storage containers for storing the individual components or the respective component groups of the kit of parts.

The disclosure is explained in more detail below with reference to figures without limiting the general concept of the disclosure.

### BRIEF DESCRIPTION OF THE DRAWINGS

In the drawings:

FIG. 1 shows a wiring element in two different manufacturing states, each in a top view,

FIG. 2 shows a detailed view of a wiring element in a perspective view,

FIG. 3 shows a cross-sectional view of the wiring element,

FIG. 4 shows a wiring element with an adhesive strip applied to the flat insulation element in a top view

FIG. 5 shows a stator with a wiring element in a plan view of the winding head,

FIG. 6 shows a first embodiment of a mold for producing a wiring element in two different manufacturing states of the wiring element, each in a cross-sectional view,

FIG. 7 shows a second embodiment of a mold for producing a wiring element in two different manufacturing states of the wiring element, each in a cross-sectional view,

FIG. 8 shows a kit of parts in a schematic block diagram.

### DETAILED DESCRIPTION

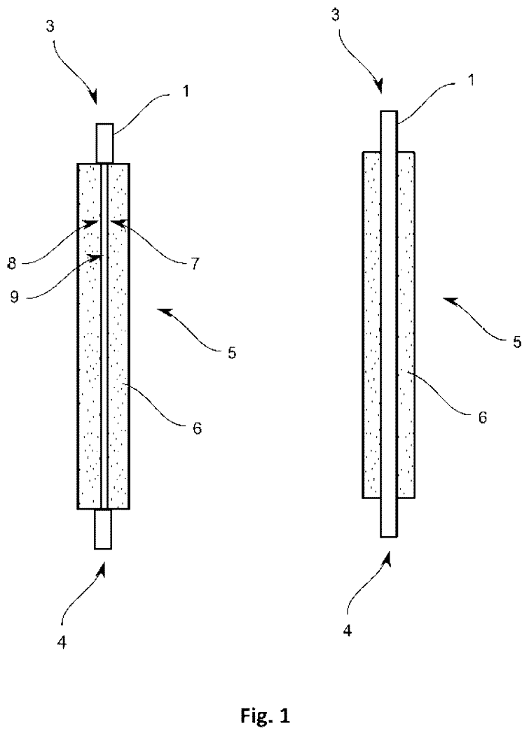

FIG. 1 shows a wiring element 1, in particular for electrically contacting two mutually spaced contact elements 2, as they occur in particular in the winding ends of stator windings or rotor windings in electric machines.

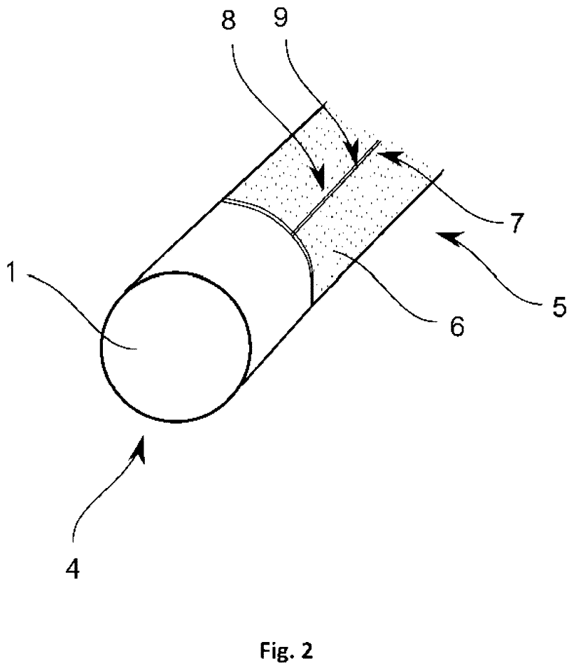

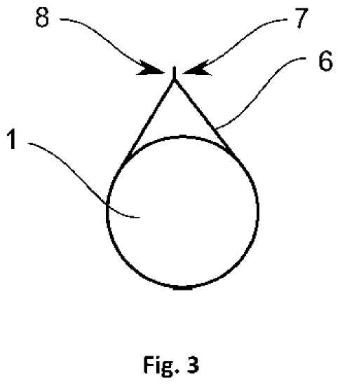

The wiring element 1 has a first wire end 3 and a second wire end 4, wherein the wiring element 1 has an insulation 5 between its first wire end 3 and its second wire end 4. The insulation 5 is made of a flat insulation element 6 that at least partly surrounds the wiring element 1, which flat insulation element has a first edge 7 extending in the longitudinal extension of the wiring element 1 and a second edge 8 extending in the longitudinal extension of the wiring element 1. The first edge 7 is fixed relative to the second edge 8 of the flat insulation element 6 by means of a bonded connection and/or a form-fitting connection such that the wiring element 1 is surrounded by the flat insulation element 6 in a tubular manner, which can be easily understood by looking at FIG. 1 together with FIGS. 2-3.

The right diagram of FIG. 1 shows the wiring element 1 inserted into the flat insulation element 6, which in this example is formed as an wiring wire with a circular conductor cross-section. The left diagram of FIG. 1 shows the closed assembly state of the flat insulation element 6, as shown, for example, in FIG. 3.

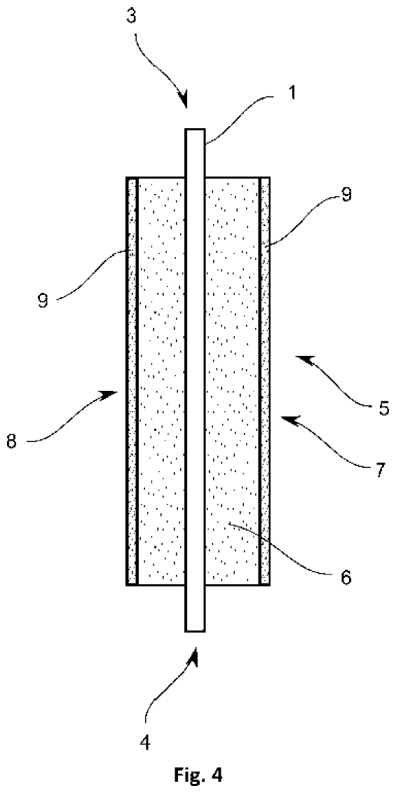

From FIG. 4, it can be seen that the bonded connection is produced by means of an adhesive 9, which is formed as a strip on the first edge 7 which extends at least partly in the longitudinal extension of the wiring element 1 and a strip extending at least partly at the second edge 8. This can be formed, for example, as an adhesive strip on the flat insulation element 6.

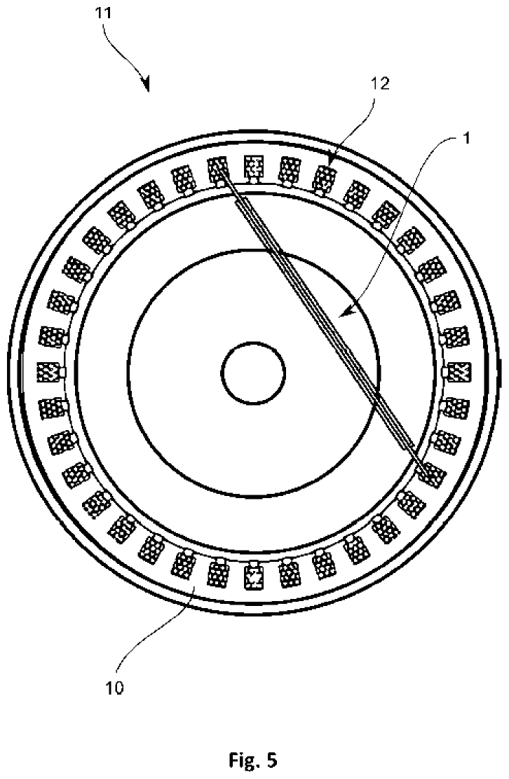

FIG. 5 shows a stator 10 of an electric machine 11 having a stator winding 12, in which a wiring element 1, as known from FIGS. 1-4, is used for the electrical wiring of the stator winding 12. Even if it is not shown in the figures, it is of course also possible that a rotor of an electric machine 11 having a rotor winding for the electrical wiring of the rotor winding also uses at least one wiring element 1, as can be seen from FIGS. 1-4.

A method for producing a stator 10 of an electric machine 11 is explained in more detail below; it comprises the following steps:

First, a stator 10 and a stator winding 12 are provided. Furthermore, a wiring element 1 is provided for electrically contacting two mutually spaced contact elements 2 of the stator winding 12. A flat insulation element 6, which has a first edge 7 extending in the longitudinal extension of the wiring element 1 and a second edge 8 extending in the longitudinal extension of the wiring element 1 is also provided.

Then an electrical contact is established between the two mutually spaced contact elements 2 of the stator winding 12 by means of the wiring element 1, which in the design example shown in FIG. 5 is two winding ends of the winding head of a stator winding. An insulation paper is provided with an adhesive strip, punched and embossed as a flat insulation element 6 and then fed to the insulation point on the wiring element 1, whereby, for example, the wire bundle of the wiring element 1 only needs to be positioned above the insulating paper.

In this state, the wiring element 1 is then inserted into the flat insulation element 6 and the flat insulation element 6 is folded over so that the wiring element 1 is surrounded in a tubular manner by the flat insulation element 6. Finally, the first edge 7 is fixed relative to the second edge 8 of the flat insulation element 6 by means of a bonded connection and/or a form-fitting connection.

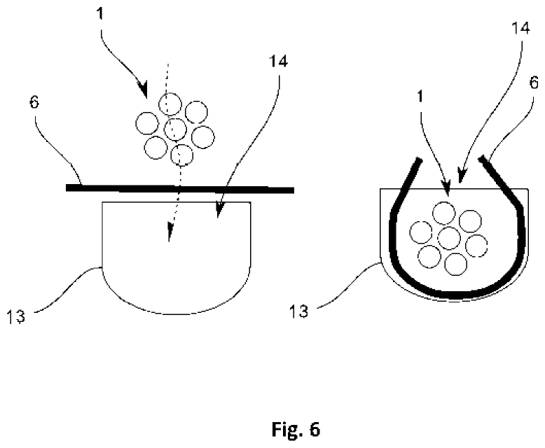

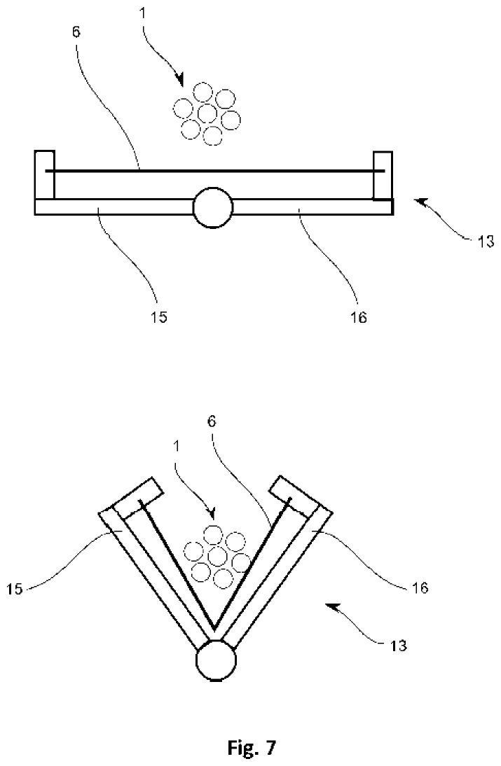

What can be seen from FIG. 6 is that before inserting the wiring element 1 into the flat insulation element 6, the flat insulation element 6 is preformed into a contour with a V-shaped or U-shaped cross-section. The preforming of the flat insulation element 6 is carried out by means of a mold 13 which has a channel 14 which is open on one side in the cross-section, in particular a V-shaped or U-shaped channel 14, into which the flat insulation element 6 is inserted. The flat insulation element 6 can, for example, be drawn into and/or held in the channel 14 by means of a negative pressure. In a further exemplary embodiment of a mold 13, which is shown in FIG. 7, the channel 14 has two channel wings 15, 16 which are movable relative to one another and which can be pivoted towards one another after the insertion of the wiring element 1.

The flat insulation element 6, which is designed as insulation paper, for example, is thus converted by means of the mold 13 from a flat shape into a V-shape or U-shape and finally into a closed shape. By enclosing the insulating point of the wiring element 1, its electrical insulation is thus created. Through the bonded connection in the insulation paper with the adhesive 9, a permanent connection is produced, wherein the wiring element 1 insulated in this way can still be laid and, for example, impregnated with resin after insulation assembly.

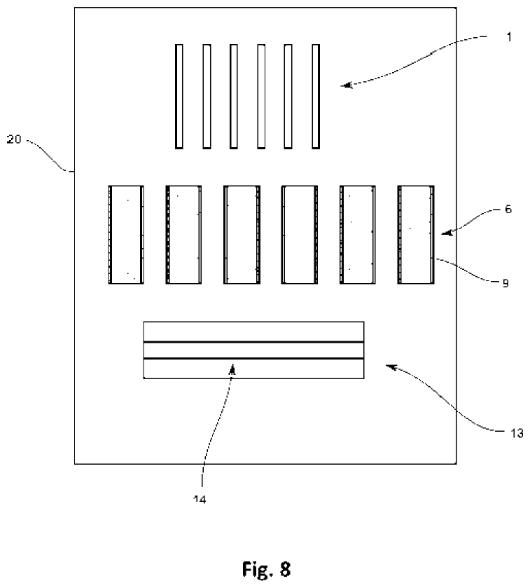

Finally, FIG. 8 shows a kit of parts 20 for producing an insulation of a wiring element 1 for electrically contacting two mutually spaced contact elements 2. This comprises a plurality of wiring elements 1 each for electrically contacting two mutually spaced contact elements 2, each having a first wire end 3 and a second wire end 4 and a plurality of flat insulation elements 6, which have a first edge 7 extending in the longitudinal extension of the wiring element 1 having a first adhesive strip 17 and a second edge 8 extending in the longitudinal extension of the wiring element 1. Finally, the kit of parts 20 also contains a mold 13, which has a channel 14 which is open on one side in the cross-section, in particular a V-shaped or U-shaped channel 14, into which the flat insulation element 6 can be inserted. In particular, the above-described method for producing an insulation of the wiring element 1 on a stator 10 can be carried out with this kit of parts 20, whereby the kit of parts 20 provides the technician with the necessary components and tools in a very convenient way.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define ‘first’ and ‘second’ features, this designation serves to distinguish between two features of the same type without defining an order of precedence.

### LIST OF REFERENCE SYMBOLS

1 Wiring element
2 Contact element
3 Wire end
4 Wire end
5 Insulation
6 Flat insulation element
7 Edge
8 Edge
9 Adhesive
10 Stator
11 Electric machine
12 Stator winding
13 Mold
14 Channel
15 Channel wing
16 Channel
17 Adhesive strips
20 Kit of parts

1. A wiring element for electrically contacting two mutually spaced contact elements
comprising: a first wire end and a second wire end, wherein the wiring element has an insulation between its first wire end and its second wire end; and
wherein the insulation is made of a flat insulation element that at least partly surrounds the wiring element,
which flat insulation element has a first edge extending in a longitudinal extension of the wiring element and a second edge extending in the longitudinal extension of the wiring element,
wherein the first edge is fixed relative to the second edge of the flat insulation element by at least one of a bonded connection or a form-fitting connection such that the wiring element is surrounded by the flat insulation element in a tubular manner.

2. The wiring element according to claim 1,
wherein
the bonded connection includes an adhesive, which is formed as a strip on at least one of the first edge or the second edge which extends at least partly in the longitudinal extension of the wiring element.

3. A stator or rotor of an electric machine comprising: a winding, and
at least one wiring element for electrically contacting two mutually spaced contact elements, the at least one wiring element including:
a first wire end and a second wire end, wherein the wiring element has an insulation between its first wire end and its second wire end; and
wherein the insulation is made of a flat insulation element that at least partly surrounds the wiring element, which flat insulation element has a first edge extending in a longitudinal extension of the wiring element and a second edge extending in the longitudinal extension of the wiring element, wherein the first edge is fixed relative to the second edge of the flat insulation element by at least one of a bonded connection or a form-fitting connection such that the wiring element is surrounded by the flat insulation element in a tubular manner,
wherein the at least one wiring element is used for the electrical wiring of the winding.

4. The stator or rotor of an electric machine according to claim 3, wherein the bonded connection includes an adhesive, which is formed as a strip on at least one of the first edge or the second edge which extends at least partly in the longitudinal extension of the wiring element.

5. A method for producing a stator or rotor of an electric machine, comprising the following steps:
provision of a stator or a rotor;
provision of a stator winding or a rotor winding,
provision of a wiring element for electrically contacting two mutually spaced contact elements of the stator winding or the rotor winding,
provision of a flat insulation element, which has a first edge extending in a longitudinal extension of the wiring element and a second edge extending in the longitudinal extension of the wiring element, a) establishing an electrical contact between the two mutually spaced contact elements of the stator winding or the rotor winding with the wiring element,
b) insertion of the wiring element into the flat insulation element,
c) folding over the flat insulation element so that the wiring element is surrounded in a tubular manner by the flat insulation element,
d) fixing the first edge relative to the second edge of the flat insulation element with at least one of a bonded connection or a form-fitting connection.

6. (canceled)

7. The method according to claim 5,
wherein
before inserting the wiring element into the flat insulation element, the flat insulation element is preformed into a contour with a V-shaped or U-shaped cross-section.

8. The method according to claim 7,
wherein
the preforming of the flat insulation element is carried out with a mold which has a channel which is open on one side in the cross-section, in particular a V-shaped or U-shaped channel, into which the flat insulation element is inserted.

9. The method according to claim 8,
wherein
the flat insulation element is drawn into and/or held in the channel by a negative pressure.

10. The method according to claim 5,
wherein
the channel has two channel wings which are movable relative to one another.

11. (canceled)

12. The wiring element according to claim 1, wherein the flat insulation element has a contour with a V-shaped or U-shaped cross-section.

13. The stator or rotor of an electric machine according to claim 3, wherein the flat insulation element has a contour with a V-shaped or U-shaped cross-section.
